(19) United States
(12) Patent Application Publication
(10) Pub. No.: US 2014/0279689 A1
(43) Pub. Date: Sep. 18, 2014

(54) HYBRID RESIMULATION-REGRESSION METHODS FOR DETERMINING POTENTIAL FUTURE EXPOSURE (PFE)

(71) Applicant: MARKIT NORTH AMERICA, INC., New York, NY (US)

(72) Inventor: Leslie Ho Ming Ng, Richmond (CA)

(73) Assignee: MARKIT NORTH AMERICA, INC., New York, NY (US)

(21) Appl. No.: 13/845,650

(22) Filed: Mar. 18, 2013

(51) Int. Cl. G06Q 40/06; G06Q 40/04

(52) U.S. Cl. CPC G06Q 40/06; G06Q 40/04
USPC 705/36 R

(57) ABSTRACT

A method for use in counterparty credit risk management systems and products to determine or calculate potential future exposure (PFE) for exotic financial investment products including some derivative products. In the method, Monte Carlo simulation is used to generate PFE scenarios. Because PFE calculations can be quite computationally demanding when the pricing model also uses Monte Carlo simulation, the method uses least squares regression with a state space sampling approach as part of the PFE determination process. Using regressions for PFE calculations may generate new or additional challenges, and the method, and systems implementing the method, include tools or processes to address these regression-related issues. Testing of the method was performed using examples of exotic interest rate products, and the numerical results are presented in the disclosure.

### BACKGROUND

1. Field of Description

The present disclosure relates, in general, to computer-implemented methods, and systems performing such methods for determining and managing counterparty credit risk, and, more particularly, to improved methods and systems for determining potential future exposure (PFE) in a more computationally efficient manner. Such PFE determination methods and systems may be used to enhance operation of counterparty credit risk management systems or tools, e.g., systems and software products used in management of exotic derivative products.

2. Relevant Background

Counterparty credit risk or exposure is a measure of the amount that would be lost in the event that a counterparty to a financial contract defaults. Contracts that are privately negotiated between counterparties, i.e., over-the-counter (OTC) derivatives, are subject to counterparty credit risk. In other words, counterparty credit risk is the risk that a counterparty in a financial contract will fail to meet its contractual obligations.

More and more exotic financial products or contracts are being created within the financial industry, but investing parties need to be able to define their liquidity and financial reserves including their counterparty credit risk to comply with financial regulations and to make prudent use of their investment assets. Without a good determination of counterparty credit risk, investors often will retain an overly large amount of funds in reserve to provide assurance that in the event of market crash or widespread economic contraction they have adequate liquidity.

In this regard, potential future exposure (PFE) calculations are used to set counterparty credit limits and to determine economic and regulatory capital requirements. PFE is sometimes defined as the maximum expected credit exposure over a specified period of time calculated at some level of confidence. PFE, hence, is a measure of counterparty credit risk and may be calculated by evaluating existing trades done against the possible market prices in the future during the lifetime of transactions. The maximum credit exposure indicated by the PFE analysis is an upper bound on a confidence interval for future credit exposure. Credit risk managers have in the past focused on current exposure management and collateral management. A problem with this focus, though, is that it places emphasis on the present and fails to provide an acceptable indication of credit risk at some point in the future. Because losses from credit risk take a relatively long time to evolve, a more useful measure of exposure is potential exposure or PFE. PFE is not like current exposure as it exists in the future and, therefore, represents a range or distribution of outcomes rather than a single point in time estimate.

While PFE determinations are useful in determining counterparty credit risk and setting related credit limits, there are a number of limitations or challenges to its use with all existing financial products and yet to be created investment vehicles. PFE calculations typically require the simulation of exposure to a counterparty at a number of future time points in many risk factor scenarios. For simple products admitting to closed form solutions for pricing, the value at a future exposure date can be directly calculated from the simulated risk factor values. However, for more exotic products such as many derivative products, the pricing has to be performed using numerical methods, and the determination of PFE can become very computationally demanding and often impractical. As noted above, this can force risk managers to avoid such exotic products or to limit their use in setting counterparty credit limits and to insure compliance with financial regulations regarding liquidity.

Hence, there is a need in the financial industry for tools and products for better determining PFE. Preferably such tools and products would not be as computationally demanding as existing methods and would be useful with all or at least more of the exotic products (e.g., exotic derivative products and the like) presently available and even yet to be offered by financial institutions.

### SUMMARY

To address the above and other issues, a potential future exposure (PFE) determination method is provided for use in counterparty credit risk management systems and products (e.g., software suites or the like). The method or technique that is used for calculating or determining PFE combines aspects of nested Monte Carlo simulation with approximate regression techniques. Hence, the method may be thought of as a hybrid resimulation-regression approach for performing PFE calculations. The method is a computationally efficient process for performing PFE calculations, which may be part of an overall counterparty credit risk management method, and the method is well suited for use with exotic investment products including derivative products.

In the past, PFE calculations for exotic derivative products were attempted by using a nested Monte Carlo simulation. However, this provided to be very computationally expensive or demanding and was not practical or even feasible in a production environment (e.g., for managing counterparty credit risk on an ongoing basis). In some cases, approximations were applied in an attempt to improve performance of a system computing PFE. However, there are many situations where the approximations broke down or led to large errors in the calculated PFE.

The new PFE-determination method taught herein combines aspects of the computationally expensive, nested Monte Carlo simulation with approximate regression techniques. By combining the inventor-identified and selected aspects of these two techniques, the PFE-determination method addresses the problem associated with large errors that can occur with the approximate regression approach and significantly improves upon the computational efficiency provided by the nested Monte Carlo approach.

Interestingly, the inventor arrived at the new PFE-determination method during concurrent investigation of the performance of the nested Monte Carlo approach and the approximate regression approach, which resulted in the inventor recognizing that the two approaches could be effectively combined to produce a new PFE-determination method. It is likely that others in the field failed to discover the new PFE-determination method in part because most people working on PFE calculations did not consider using the nested Monte Carlo approach for PFE calculations because it was generally considered to be too computationally intensive to be useful in most if not all settings. However, the combined approach provided in the new PFE-determination method significantly increases performance to make it computationally feasible and practical for inclusion in a counterparty credit risk management system or software product.

More particularly, a method is provided for generating a potential future exposure (PFE) profile in a more computationally efficient and practical manner. The method includes providing a PFE-determination engine, e.g., with a processor executing code or instructions accessible in a computer-readable medium causing the processor and/or computing device with such a processor to perform functions that make it a special purpose computer. The method includes, with the PFE-determination engine, generating PFE scenarios for a portfolio of trades stored in memory at a number of exposure dates. Then, with the PFE-determination engine, the method includes calculating, for each of the trades in the portfolio at each of the exposure dates, expected future values. Further, the method includes calculating exposure of the portfolio based on the calculated expected future values and, then, generating a PFE profile using a distribution of the exposure at each of the exposure dates. The method may further include using the generated PFE profile to perform regulatory reporting, to determine capital requirements for the portfolio of trades, and/or to set credit limits with a counterparty associated with the portfolio of trades

In some implementations, the step of calculating of the expected future values includes calculating hybrid regression estimates for the expected future values. Then, the method may also include using a combined estimator using the hybrid regression estimates along with data from a full resimulation estimate for the expected future values to provide the calculated expected future values.

In many cases, the trades include a number of exotic products such as derivatives or interest rate financial products requiring a number of variables for pricing at a future date. Particularly, the step of calculating the expected future values of these exotics may be performed using a numerical method with an inner pricing model. In some cases, the numerical method includes performing a Monte Carlo simulation.

It will be understood that use of the PFE-determination method taught herein can be provided in a software product or package (e.g., that may be provided in a counterparty credit risk management system or other special purpose computer implementation). The use of the PFE-determination method will allow investment or financial institutions to include trade types that may not be currently supported in their counterparty credit risk calculations. Also, those skilled in the financial product and risk management arts will readily recognize and understand that the method taught herein is not limited to use in determining PFE. The techniques may be applied to perform calculations similar to calculating PFE such as, but not limited to, credit value adjustment (CVA) and initial margin (IM) calculations.

### BRIEF DESCRIPTION OF THE DRAWINGS

FIG. 1 is a graph providing an exemplary Black-Scholes PFE plot for illustrating the effect of distribution errors on PFE calculations;

FIG. 2 is a graph providing an exemplary Black-Scholes distribution plot further illustrating the effects of distribution errors on PFE calculations;

FIG. 3 showing graphically results using a BGM outer model and a single factor Hull-White inner model for performing PFE calculations on an inverse floater trade using full resimulation and hybrid methods taught herein;

FIGS. 4-7 provide distribution plots for several exposure dates, i.e., FIG. 4 provides an inverse floater distribution plot at 313 days (BGM outer, HW 1F inner) using MTM regression, FIG. 5 provides an inverse floater distribution plot at 648 days (BGM outer, HW 1F inner) using MTM regression, FIG. 6 provides an inverse floater distribution plot at 1033 days (BGM outer, HW 1F inner) using MTM regression, and FIG. 7 provides an inverse floater distribution plot at 1685 days (BGM outer, HW 1F inner) using MTM regression;

FIG. 8 illustrates graphically PFE error plots for various PFE-determination methods similar to that of FIG. 3 but for a cancelable inverse floater trade (BGM outer, HW 1F inner);

FIG. 9 illustrates a graph providing a error plots for various PFE-determination methods for a CMS spread trade (BGM outer, HW 4F inner);

FIGS. 10-12 provide distribution plots for several various PFE-determination methods as provided in FIG. 9 at a particular exposure date, i.e., FIG. 10 provides a CMS spread distribution plot at 1968 days (BGM outer, HW 4F inner) using MTM regression, FIG. 11 provides a CMS spread distribution plot at 1968 days (BGM outer, HW 4F inner) using hybrid regression with bucketing, and FIG. 12 provides a CMS spread distribution plot at 1968 days (BGM outer, HW 4F inner) using hybrid regression without bucketing;

FIG. 13 illustrates graphically PFE error plots for a CMS spread trade using the combined estimator (BGM outer, HW 4F inner);

FIG. 14 illustrates graphically PFE error plots for various PFE-determination methods for a cancelable CMS spread trade (BGM outer, HW 4F inner);

FIG. 15 illustrates graphically PFE error plots for a CMS spread trade for various PFE-determination methods (HW 4F outer, BGM inner);

FIGS. 16 and 17 illustrate distribution plots at 313 days for the CMS spread trade of FIG. 15 using MTM regression and the combined estimator with bucketing, respectfully (HW 4F outer, BGM inner);

FIG. 18 illustrates graphically PFE error plots for various PFE-determination methods for a cancelable CMS spread trade (HW 4F outer, BGM inner);

FIG. 19 is a flow diagram of a method for calculating or determining PFE according to the present description and as may be carried out by a computer/processor executing program code or software in computer readable media or memory (e.g., functions in flow diagram are performed by a counterparty credit risk management system or other computer system);

FIG. 20 illustrates a flow diagram for a standard full resimulation procedure;

FIG. 21 illustrates a flow diagram for hybrid resimulation-regression procedure;

FIG. 22 illustrates a flow diagram for a hybrid resimulation-regression procedure using a combined estimator; and

FIG. 23 is a functional block diagram of a computer network/system including a counterparty credit risk management system (e.g., special-purpose computer) executing code or instructions associated with a PFE determination method (e.g., to provide a PFE determination engine or tool).

### DETAILED DESCRIPTION

The following description describes the use of software (and/or hardware) implementations to provide counterparty credit risk management and, particularly, to determine or calculate potential future exposure (PFE) in a computationally practical manner (i.e., one that is less demanding than prior PFE calculation techniques). To this end, a PFE-determination method may be performed by implementing a PFE mechanism or module (e.g., a suite of software programs or a software product) that is run or executed as a standalone component or as part of a counterparty credit risk management system.

In the following description, numerical methods for use in PFE calculations on exotic products are described in detail. An exotic product is any of a number of asset classes, such as many derivative products, that require several-to-many variables to value or price (e.g., to evaluate an exotic product 3 or more variable may have to be determined or processed). The description begins with a general explanation of existing PFE calculations and then proceeds to explanation of the state space sampling procedure that can be used to accelerate the calculation for exotic products. The description then moves to an overview of the least-squares regression-based approach and how it can be applied to PFE calculations. Limitations and shortcomings of this approach are discussed along with a procedure that combines regression with full resimulation to address these limitations or shortcomings. The description also includes examples of use of the PFE-determination method taught herein along with exemplary numerical results. Further, the description presents a PFE-determination method that uses multiple regressions to provide improved results.

As an initial step to discussing PFE calculations, it may be useful to define the counterparty exposure, E(t), at some future date, t, to be the value, floored at zero, of the entire portfolio of trades entered with a given counterparty. The counterparty exposure can be given by the following equation:

E(t)=max(V(t),0) Equation 1:

where V(t) is the value of the portfolio at time t. This corresponds to the net loss incurred if the counterparty was to default and no amount was recovered. The PFE at a future exposure date, t, is obtained from the distribution of simulated counterparty exposures at time t. PFE(t) is a user-specified percentile of this distribution such as the 95^{th} percentile. The function t->PFE(t) is called the PFE profile.

Monte Carlo simulation can be used to generate the distribution of the counterparty exposures. The model used to generate the PFE exposure scenarios may be referred to as the outer model or the PFE simulation model. As the PFE calculation is used to account for all trades with a given counterparty, the outer model is used to capture correlations between all risk factors relevant to the portfolio. Also, the outer model is usually simulated using the real world measure.

For example, one can denote Xₒᵤₜₑᵣ(t) as the risk factors generated by the outer model at time t. The value of the portfolio, V(t), at time t and, thus, the exposure, E(t), is a function of the risk factors, Xₒᵤₜₑᵣ(t). More formally, the pth percentile PFE at time t can be expressed using the following equation:

PFEₚ(t)=E(t,X^{(p)}ₒᵤₜₑᵣ(t)) Equation 2:

where, Xₒᵤₜₑᵣ^{(p)}(t)={Xₒᵤₜₑᵣ [symbol] Prob[E(t,Xₒᵤₜₑᵣ^{(p)})<E(t,Xₒᵤₜₑᵣ [symbol] )]=p}

Next, one can look at how to calculate the value of the portfolio, V(t), at future times t. It can be assumed that the value of the portfolio, V(t), is the sum over the individual values of each trade, Vᵢ(t), as given by:

$$V ( t ) = {\sum }_{\text{?} = \text{?}}^{{N}_{\text{?}}} {V}_{\text{?}} ( t ) \\ \text{?} \text{indicates text missing or illegible when filed} \qquad Equation 3$$

For simple trades that admit to closed form solutions such as swaps or forwards, values can often be calculated directly from the simulated risk factor values, Xₒᵤₜₑᵣ(t) as shown by:

V [symbol] (t)=V [symbol] (t,Xₒᵤₜₑᵣ(t)) Equation 4:

For more complicated trades that do not have closed form solutions such as many types of exotic products, values may be obtained by numerically evaluating the risk neutral expectations conditional on the risk factors, Xₒᵤₜₑᵣ (t), as shown by the following equation:

$${V}_{\text{?}} ( t ) = N ( t ) 𝔼 [ \frac{CF ( τ > t )}{N ( τ )} \vert {X}_{outer} ( t ) ] \\ \text{?} \text{indicates text missing or illegible when filed} \qquad Equation 5$$

where N(t) is the numeraire value at time t and CF(τ>t) are the future cash flows of the trade.

Now, the model used to evaluate the expectation in Equation 5 may be referred to as the inner model or the pricing model. The risk factors generated by the inner model at time t may be denoted as Xᵢₙₙₑᵣ(t). In practice, the pricing model does not need to be the same as the PFE simulation model as long as there exists a transformation that maps risk factors from the outer model to risk factors in the inner model, such as the following:

Xᵢₙₙₑᵣ(t)=Φ(Xₒᵤₜₑᵣ(t)) Equation 6:

A different pricing model may be used for each trade, and the model does not need to contain the same risk factors as the outer model as long as a mapping exists. There may be several reasons why one may want to use different models or measures for inner and outer models. For example, a real world measure is often used to generate PFE scenarios with the outer model. However, the pricing model should be a risk-neutral model as it is used to determine the present value of possible future cash flows. Another example is when trades in a portfolio may use different models for mark-to-market (MTM) pricing, and it may not be practical to create an outer model that is consistent with all the different inner models used for MTM pricing.

At this point in the discussion of the new PFE-determination method, it may be useful to discuss state space sampling. Since PFE calculations involve pricing in many different scenarios at many future time points, the PFE calculation can be quite computationally intensive for more complicated trades that require numerical methods to evaluate the expectation (as defined by Equation 5). The numerical procedure used to perform the pricing calculation with the inner model should be repeated for each scenario and time point generated by the outer model.

One possible approach to improve the performance of the PFE calculation is to first generate a state space of prices for all future exposure dates. Then, instead of re-pricing the counterparty portfolio at every time step of every scenario, the populated state space may be sampled to obtain the counterparty exposure for each PFE scenario. This approach can be referred to as state space sampling. The state space sampling procedure can be directly applied to trades that can be priced using finite difference or tree methods. Here, a state space of state-contingent prices can be automatically generated as part of the backward iterative pricing procedure. This state space can evidently be used for state space sampling in PFE calculations. However, backwards pricing methods are usually limited to problems with only a small number of factors (e.g., up to 3 or 4).

When backwards pricing methods cannot be applied to price a trade, Monte Carlo simulation is often required or used as part of the PFE determination. A regression-based approach can be combined with Monte Carlo simulation to approximate the conditional expectations required in Equation 5. With this in mind, it may be useful now to present an overview of the regression-based approach.

A relatively simple Monte Carlo-based method may be defined for pricing options with early exercise features. For example, least-squares regression may be used to approximate the continuation value at every exercise date. The continuation value, C(t), at some future time t is the numeraire adjusted expectation of all future cash flows, CF(τ>t), as shown in the following equation:

$$C ( t ) = \frac{V ( t )}{N ( t )} = 𝔼 [ \frac{CF ( τ > t )}{N ( τ )} \vert X ( t ) = x ] \qquad Equation 7$$

where X(t) are the risk factors of the pricing model at time t.

The method approximates the conditional expectation as shown in the following equation:

$$𝔼 [ \frac{CF ( \text{?} )}{N ( τ )} \vert X ( t ) = x ] \text{?} {\sum }_{\text{?} = \text{?}}^{M} {β}_{k} {ψ}_{k} ( x ) \\ \text{?} \text{indicates text missing or illegible when filed} \qquad Equation 8$$

for some basis functions, ψₖ, and constants, βₖ. The constants, βₖ, are obtained by performing a least-squares regression on a set of pre-simulated paths. The basis functions used are typically polynomials over a set of explanatory variables that can be calculated from the model risk factors. The explanatory variables are chosen to be quantities (such as a set of Libor rates or swap rates in the case of an interest rate product) that are representative of the value of the trade. The performance of a particular choice of basis functions and explanatory variables is typically trade dependent. At each exercise date, the decision whether to exercise or not is determined by comparing this estimation of the continuation value with the numeraire adjusted exercise value. If the exercise value cannot be computed analytically, an additional regression can also be performed to provide an estimate. The exercise information is then stored and used in any subsequent regressions.

With regard to state space sampling using regression, the regression-based approach used to estimate conditional expectations can also be applied to state space sampling in PFE calculations. The concept is similar to the description above regarding state space sampling with backwards pricing methods (e.g., tree and finite difference techniques). Using the paths generated from a regular mark-to-market (MTM) Monte Carlo pricing run, a regression may be performed at each exposure date to provide an estimate for the expectations of Equation 5, which are used for PFE calculations.

Two important sources of error can be highlighted when using regression-based approaches for PFE calculations. A first source of error is the distribution errors due to the differences between the distribution used to perform the regressions with the distribution used in the actual PFE calculation. A second source of error is the projection errors due to the choice of basis functions and explanatory variable used in the regression.

With regard to distribution errors, as discussed above, the outer model used to generate PFE scenarios does not need to be the same as the inner pricing model used to evaluate the expectations used in the PFE calculation. Even if the same model is used for the outer and inner models, the PFE scenarios are usually generated using the real world measure while pricing using the inner model is performed using a risk-neutral measure. Thus, if Monte Carlo paths from a MTM pricing run are used for the PFE calculations, the distributions used to generate the regressions can be quite different from the actual distribution used in the PFE scenarios.

A simple example can be used to illustrate the effect of distribution errors on PFE calculations. A Black-Scholes model on an asset, S(t) may be described by:

ds(t)=rS(t)dt+σS(t)dW(t) Equation 9:

with risk-free rate r=0.05, volatility σ=0.15, and initial value S(0)=100.

FIG. 1 illustrates with graph 100 an exemplary Black-Scholes PFE plot. The graph 100 shows the 97^{th} percentile PFE calculated for a call option with expiry Tₑₓ=3.5 (see the X-axis of graph 100) and strike K=100, where PFE scenarios are generated using a real world drift of μ=0.2. In this simple example, the option value on exposure dates can be calculated analytically as shown with line 110. Also shown in FIG. 1 with line 120, the PFE can be calculated using state space sampling with regression surfaces obtained from a set of paths generated using the risk neutral distribution (e.g., for MTM pricing). In the example of FIG. 1, one hundred thousand paths were used with a cubic polynomial on S(t) in the regression.

To further illustrate the effects of distribution errors, FIG. 2 provides with graph 200 an exemplary Black-Scholes distribution plot. The graph 200 shows how well the future option price is approximated by the regression on the exposure date at t=2. The real world and risk neutral distributions, which are shown by lines 210 and 220, respectively, are shown along with the locations of the 97^{th} percentiles (with vertical dashed lines) on lines 230 and 240 showing PFE analytical and least-squares-based calculations of PFE.

In FIG. 2, it can be seen that V(t) is well approximated by the regression over the risk neutral distribution (as would be expected). However, the regression does not provide as good an approximation over the range of values corresponding to the real world distribution. Particularly, around the upper tail of the real world distribution where the PFE percentile is calculated, the difference between the regressed value and the analytic value can be seen to be significantly large.

The inventor recognized that a regression surface can only provide a good approximation to the region covered by the distribution that the regression was performed on. Using a regression surface to obtain values outside the distribution points the regression was performed on may provide poor results. In effect, the approximation involves extrapolating the surface, which is undesirable and can lead to large errors in PFE calculations. The issues associated with extrapolation may not be as problematic when sampling with state spaces generated using finite difference methods. This is because the range of risk factor values used in finite difference calculations can be explicitly specified. Thus, a fairly large range can be selected unlike MC-based regression methods, where the range of risk factor values is not as easily controlled (generating points in the tails of the distribution requires a large number of paths). However, even though it is easier to control the range of risk factor values in the state space using finite difference methods, it is still not always possible to guarantee that extrapolation does not occur.

Turning to PFE calculations and effects of projection errors, as previously discussed, the regression-based approach requires a specific choice of basis functions and explanatory variables, which affects how well the PFE-determination method works. The errors associated with the choice of basis functions and explanatory variables may be referred to as projection errors. All the issues regarding the choice of basis functions and explanatory variables for MTM pricing are also important when using regressions for PFE calculations. Although a specific choice of basis functions and explanatory variables may give satisfactory results for MTM pricing, it may not give good results for PFE calculations. For MTM pricing, the regression estimates are only used for making exercise decisions, and good approximations to the continuation value are only required near the exercise boundary.

However, when using regressions for PFE calculations, a good approximation over the entire state space is important and desirable, particularly in the tails of the underlying risk factor distribution. One possible way to reduce the effect of projection errors is to use higher order polynomials, which allows the regression surface to take on a wider variety of shapes. While using higher order polynomials may be able to better model features of the distribution used for the regression, it can also lead to large errors if the surface is used to extrapolate values outside of the regression distribution.

At this point, the description can now turn to a detailed discussion of improved techniques for state space sampling using regression. Particularly, the above paragraphs discussed two main sources of error that can occur when applying regression-based approaches to PFE calculations, and the following paragraphs present improved techniques to address some of these issues or sources of error.

First, it may be useful to discuss a hybrid regression-resimulation approach to PFE calculations. As previously discussed, differences between the distribution used to generate the regression surface and the distribution of the PFE scenarios can lead to significant errors. One way to avoid this problem and associated errors is to generate the paths used in the regression using the actual distribution required for the PFE scenarios.

For a given exposure date, tₙ, it can be assumed there is a set of PFE scenarios defined by the risk factor values, Xₒᵤₜₑᵣ(tₙ). As previously described with regard to Equation 6, it can also be assumed there is a well-defined mapping between risk factors of the outer model and the inner model. The set of points, Xᵢₙₙₑᵣ(tₙ)=Φ(Xₒᵤₜₑᵣ(tₙ)), defines the distribution of interest in the PFE calculation. A goal may be to use regression to obtain an approximation as provided by the following equation:

\tilde{V}(tₙ|Xᵢₙₙₑᵣ(tₙ)) [symbol] V(tₙ|Xᵢₙₙₑᵣ(tₙ)) Equation 10:

where paths are generated with the inner model. Rather than using a set of paths from a MTM pricing run to obtain an approximate regression surface \tilde{V}(tₙ|Xᵢₙₙₑᵣ(tₙ)), one can instead generate a new set of paths by simulating the inner model with starting values, Xᵢₙₙₑᵣ(tₙ), to the required future cash flow dates τ>tₙ. Although more computationally intensive than using the same set of MTM paths for regressions as a separate simulation is required for each exposure date, the procedure guarantees that the paths used for the regression reflect the distribution of the PFE scenarios at the exposure date.

An issue that arises is that the number of PFE scenarios typically used (e.g., a few thousand) is often less than the number of paths needed to generate a stable regression surface (e.g., 10,000 to 50,000 or more). One solution is to introduce additional paths in the simulation by replicating the PFE scenarios at the exposure date. For example, it can be assumed that 1000 scenarios are used in the PFE calculation. For each exposure date, the inner model can be restimulated using 10,000 paths made up of 10 copies of each of the 1000 PFE scenarios. In other words, for each PFE scenario, k=1, . . . , 1000, ten paths are simulated for each set of starting values, X^{(k)}ᵢₙₙₑᵣ(tₙ). The regression is now performed using all 10×1000=10,000 paths. Note, there is a relationship between the procedure that has been described and full Monte Carlo resimulation where a separate simulation is performed to calculate V^{(k)}(tₙ)=(tₙ|Xᵢₙₙₑᵣ(tₙ)) for each of the k PFE scenarios. Using the 10×1000=10,000 paths in this example, one could also calculate a value for V^{(k)}(tₙ) that corresponds to full resimulation with 10 paths per scenario by averaging over the replicated paths.

The procedure that has been presented herein can be viewed as a hybrid approach that is a combination of full resimulation and regression. The regression allows information to be shared across paths with different initial conditions corresponding to individual PFE scenarios. As a result, fewer resimulation paths for each PFE scenario can be used in the hybrid approach compared with the pure full resimulation method.

Generating regression paths using the actual PFE scenario distribution addresses some of the problems associated with distribution errors. As the regression surface is now calculated using paths that reflect the distribution of interest, the issues previously discussed regarding extrapolation are avoided. In addition, it is safer to use higher order polynomial basis functions if regressions are performed using paths generated as described above or herein.

With regard to a combined estimator, the hybrid approach may be used at a given exposure date, tₙ, to provide two estimates for the required V^{(k)}(tₙ). These two estimates include a full resimulation estimate V^{(k)}_{RS}(tₙ) obtained by averaging only over replicated paths for each scenario and a hybrid regression estimate V^{(k)}_{H}(tₙ) obtained by regressing over all the resimulation paths. A new estimator can then be defined that combines information from both full resimulation and hybrid regression results as shown in the following equation:

V [symbol] ^{(k)}(tₙ)=W^{(k)}V_{RS}^{(k)}(tₙ)+(1−W^{(k)})V_{H}^{(k)}(tₙ) Equation 11:

where W^{(k)} is a weighting term. Note also that the standard error, σ^{(k)}_{RS}(tₙ), of the resimulation estimate, V^{(k)}_{RS}(tₙ), can be readily computed. The standard error, σ^{(k)}_{H}(tₙ), of the hybrid regression estimate, V^{(k)}_{H}(tₙ), can also be computed. Weights, can be selected as shown by the following equation:

$${W}^{( k )} = \frac{{σ}_{{H ( {t}_{n} )}^{2}}^{( k )}}{{σ}_{H}^{( k )} ( {t}_{n} ) 2 + {σ}_{{RS ( {t}_{n} )}^{2}}^{( k )}} \qquad Equation 12$$

By selecting the weights as shown, the combined estimator, V [symbol] ( [symbol] )(tₙ), is more heavily weighted to whichever estimate has smaller standard error.

With regard to the second main source of error, it may be useful to discuss bucketed regressions. The second main source of error that was discussed above was projection errors. The approach described in the previous paragraphs addresses some of the issues associated with projection errors when using higher order basis functions. However, it is still often desirable to use lower order polynomials as the surfaces are more stable and require fewer paths to obtain good approximations (and, thus, the process is more computationally efficient).

Hence, the inventor proposes a method that tries to address some of the problems associated with projection errors when using lower order polynomials as basis functions. The method involves splitting up the simulation paths into multiple subgroups (or “buckets”) and performing separate regressions for each subgroup or bucket. For ease of explanation but not as a limit to the present invention, the discussion may be limited to the case involving only two subgroups or buckets, but it is relatively straightforward to extend the concepts to multiple subgroups or buckets.

For some exposure date, tₙ, there may be a set of paths with the j^{th} path going through the point X^{(j)}ᵢₙₙₑᵣ(tₙ). in risk factor space. Using the entire set of paths, an approximate value can be obtained through regression \tilde{V}₀(tₙ). The starting approximate regression value for the j^{th} path may be defined as:

\tilde{V}₀^{(j)}(tₙ)=\tilde{V}₀(tₙ|Tᵢₙₙₑᵣ [symbol] (f)(tₙ)) Equation 13:

The set of paths can now be sorted according to \tilde{V}₀^{(j)}(tₙ). Next, the paths can be divided into two subgroups according to the sorting order determined by the approximate regressed values \tilde{V}₀^{(j)}(tₙ). For example, there may be a set of 10,000 paths (j=1, . . . , 10000). The paths can be divided up into two subgroups: one subgroup kₗ⊂j containing the 5000 paths with the lowest values of \tilde{V}₀^{(j)}(tₙ) and one subgroup kₕ⊂j (kₕ∉kₗ, kₗ∪kₕ=j) containing the 5000 paths with the highest values of \tilde{V}₀^{(j)}(tₙ). For each subgroup, a separate regression can be performed using only the paths in the subgroup. Then, a new approximate regression-based value is obtained using the following equation:

$${\tilde{V}}_{1}^{( j )} ( {t}_{n} ) = \{ \begin{matrix}{\tilde{V}}_{1 , l} ( {t}_{n} \vert {X}_{inner ( {t}_{n} )}^{( j )} ) , j ∈ {k}_{l} \\ {\tilde{V}}_{1 , h} ( {t}_{n} \vert {X}_{inner ( {t}_{n} )}^{( j )} ) , j ∈ {k}_{h}\end{matrix} \qquad Equation 14$$

where \tilde{V}_{1,l}(tₙ) and \tilde{V}_{1,h}(tₙ) are the regression surfaces generated using paths from only the low or high subgroup, respectively.

A core idea of the method is to perform regressions using points that have similar values making it easier for lower order basis functions to approximate the expectations. An important point to note is that the subgroups are determined using an approximate value for the price, which only requires a one dimensional sorting algorithm that can be computed efficiently. The subgroups are not determined using the actual risk factor values, which can be quite computationally expensive for multi-dimensional problems.

The bucketed regression procedure can be iterated several times, each time re-sorting using the most recent approximation for \tilde{V}^{(j)}(tₙ). Also note, the cost of resimulation is usually the most computationally expensive part of the calculation so performing several iterations of the bucketing procedure is not likely to add much to the overall computation time.

With the above discussion of the hybrid resimulation-regression method for determining PFEs understood, it may be useful to provide some examples of using this method with certain exotic products. Particularly, the following presents some examples of exotic interest rate products using different choices of inner and outer models for the PFE calculations. For outer models, the examples use either a Brace-Gatarek-Musiela (BGM) model or a multi-factor Hull-White model. For inner models, the examples use either a BGM model, a multi-factor Hull-White model, or a single factor Hull-White model. Also, for the inner model, a forward measure is used that corresponds to the last cash flow of the trade. For outer models, the risk-neutral measure (or rolling spot Libor measure for BGM) is used. Although the examples do not use actual real world measures for the outer model, the examples considered effectively illustrate the effect of using different models and measures for the inner and outer models.

The following PFE calculations, 1000 scenarios were used that were generated by the outer model and exposure dates spaced no more than 10 days apart. The test trades that were considered were swaps starting in three months and going out ten years in length. The swaps have quarterly payments based on a $1 notational. Floating payments based on 3-month Libor are received and a structured coupon is paid. It was further assumed that all coupon amounts are calculated using a year fraction of 0.25.

Initially, an inverse floater test trade may be considered with the new PFE determination method. Such a trade may be an inverse floater with a structured coupon rate given by:

InverseFloaterRate=max[kₗ×3mLibor+k [symbol] o] Equation 15:

where 3 mLibor is the 3-month Libor rate, kₗ=−2, and kₛ=0.15. Note, the trade can be priced analytically as there are analytic formulae for caplets for all the models considered in these examples. For this trade type, the 3-month Libor rate can be used, and the coterminal swap rate as explanatory variables in the regression calculation. Basis functions used were the 3^{rd} order polynomials of the explanatory variables.

To evaluate the performance of using different methods to obtain the conditional expectations required in the PFE calculation, the sum can be calculated at each exposure date over all scenarios of the absolute error with the analytic value. FIG. 3 shows in graph 300 the results using a BGM outer model and a single factor Hull-White inner model. All regression calculations were performed using 20,000 paths which means “full resimulation” as shown with line 310 and “hybrid regression” calculations as shown with line 320 used 20 paths for each of the 1000 outer scenarios. Regression results as shown with line 330 obtained using a single set of paths generated from a MTM pricing run may be referred to as “MTM regression.” The results using bucketing are shown with line 340.

In the graph 300 of FIG. 3, it can be seen that the sum of absolute errors can be quite large when using full resimulation or MTM regression. The full resimulation errors are purely due to the low number of resimulation paths used per scenario (20 in this example). The errors from full resimulation appear to decrease with time, but it can also be noted that the number of cash flows remaining in the swap also decreases with time. For short and medium-term exposure dates, the errors using the hybrid regression approach are significantly smaller than the errors from full resimulation. The computational effort required for full resimulation and hybrid regression calculations are similar, but the hybrid approach produces significantly better results for these cases. In this example, for longer dated exposures, using full resimulation produces smaller errors than the hybrid regression approach. However, the hybrid regression errors are not very large in this example.

For this test case, it can be observed that the errors from using MTM regression can be quite large for longer dated exposures. This may be attributed to the effect of distribution errors resulting in an extrapolation of the regression surface. To illustrate this, the analytic and MTM regression results may be plotted for the entire distribution of PFE scenarios at selected exposure dates. For these distribution plots, the scenarios may first be sorted using the analytic value, which makes it easier to visualize the results for higher dimensional cases, i.e., multi-factor models. FIGS. 4-7 provide graphs 400-700 showing the distribution plots for several exposure dates.

For this test case and with reference to FIGS. 4-7, it can be observed that errors in the MTM regression results are concentrated near the high value scenarios and can get quite large for longer exposure dates. These large errors occur for scenarios with risk factor values that lie outside the range of the MTM distribution used in the regression leading to extrapolation of the regression surface. These large extrapolation errors do not occur when using hybrid regression. Also, for this example when using hybrid regression, it can be seen that bucketing gives slightly worse results than non-bucketing for early exposure dates while for later exposures bucketing performs better. This may be because at longer exposure dates the surface the regression is trying to capture has more variation making it more difficult to approximate for a given set of basis functions. Thus, the effect of projection errors is more significant which bucketing attempts to address. In contrast, for shorter exposures, the surface has less variation resulting in smaller projection errors thus reducing the effectiveness of bucketing. As the bucketing procedure uses fewer paths in each regression calculation, there is more noise in the regression coefficients leading to larger errors.

Now, a cancelable version may be considered for the same inverse floater trade where the holder has the right to terminate the trade at each cash flow date. Because of the optionality, there is no longer an analytic formula available for this trade. Since this test case uses a single factor Hull-White inner model, a finite difference may be used to generate values to compare against. FIG. 8 shows with graph 800 the sum of absolute error plots for the various PFE-determination methods that use regression with lines 820, 830, 840 as compared with full resimulation results with line 810. The error plots 810-840 exhibit similar features as seen with the non-cancelable trade of FIG. 3-7.

Another test trade considered was a CMS spread where the structured coupon rate was equal to a leverage factor, kₗ, times the spread between two constant maturity swap (CMS) rates floored at zero as shown by:

CMSSpreadRate=max[kₗ×(CMS2−CMS1),0] Equation 16:

where the CMS rates CMS1 and CMS2 are the 2 and 30-year swap rates based on quarterly payments and k₁=5. For the models considered, although there is no closed form solution, there are analytic approximations for valuing the payoff described in Equation 16. For CMS spread trades, the 3-month Libor rates may be used along with the coterminal swap rate and the two coupon CMS rates as explanatory variables in the regression calculation. Basis functions may be taken as 3^{rd} order polynomials of the explanatory variables.

For the first test case regarding CMS spread trades, a BGM model may be used with a 4-factor Hull-White inner model. The results are shown with graph 900 of FIG. 9. For this test case, the errors using MTM regression as shown with line 920 are not as large as seen for the inverse floater example using a single factor Hull-White model. However, there are still fairly significant errors for high value scenarios when using MTM regression. Results for full resimulation, hybrid regression, and bucketing are shown with lines 910, 930, and 940, respectfully.

FIG. 10 illustrates with graph 1000 a distribution plot for MTM regression results at an exposure date of 1968 days. Again, the error may be attributed to extrapolation of the regression surface. In contrast, FIG. 11 shows a distribution plot with graph 1100 using hybrid regression with bucketing for the same exposure date. Here, the errors are much smaller particularly for certain high value scenarios. In FIG. 9, it can also be seen that the use of bucketing in the hybrid regression procedure significantly reduces the errors for this example. FIG. 12 shows with graph 1200 a distribution plot at 1968 days for hybrid regression without bucketing. Comparing FIG. 12 with FIG. 11 illustrates the improvements obtained using bucketing. An interesting artifact seen in FIG. 9 is a peak at around 3000 days visible for all regression-based methods. This peak is due to the choice of basis functions. For explanatory variables, a 2-year CMS rate and a coterminal swap rate are used. For exposures around 3000 days, the coterminal swap rate corresponds to the 2-year CMS rate causing a degeneracy of the explanatory variables resulting in a poorer regression fit.

In this example, FIG. 9 shows that using full resimulation produces better results than the hybrid regression approach for medium and longer dated exposures. At this point, results can be presented for the combined estimator (explained above) that attempts to combine information from both the full resimulation and the hybrid regression results. FIG. 13 provides a graph 1300 showing full resimulation (with line 1310) and hybrid regression results (with line 1320) along with results (with line 1330) using the combined estimator and with results (with line 1340) using the combined estimator with bucketing. For shorter term exposures where hybrid regression performs better than full resimulation, the combined estimator produces results similar to hybrid regression. However, for longer dated exposures where full resimulation performs better than hybrid regression, the combined estimator produces better results than using hybrid regression alone by utilizing additional information from full resimulation.

FIG. 14 displays with graph 1400 error plots for the cancelable version of the CMS spread trade. Note, as the cancelable trade no longer has an analytic solution, full resimulation results are used with 1000 paths as a base case in place of the analytic value, i.e., errors are reported with respect to the 1000 path full resimulation results. FIG. 14 shows similar behavior as observed with the non-cancelable CMS spread trade.

Next, a four factor (4F) Hull-White outer model may be used with a BGM inner model. FIG. 15 provides a graph 1500 displaying the resulting error plots. In this test case, a different behavior can be observed compared with the above test cases in that the MTM regression results (see line 1520) exhibit large errors at earlier exposure dates. In FIG. 15, the y-axis is only displayed up to 100, but the results can have values as large as 500. FIGS. 16 and 17, respectfully, show with graphs 1600 and 1700 the distribution plots for MTM regression and using the combined estimator with bucketing at an exposure date of 313 days. The results using the combined estimator have much smaller errors than the MTM regression results. Note, using MTM regression can result in large errors over different parts of the distribution (not just for high value scenarios as observed in the previously discussed test cases). FIG. 18 provides results of a cancelable version of the CMS spread trade, and the graph 1800 shows similar behavior as observed with the non-cancelable trade.

In the inverse floater example with BGM outer model and single factor Hull-White inner model, it was observed that large errors caused by extrapolation could occur for longer dated exposures when using MTM regression. In contrast for the CMS spread with a four factor Hull-White outer model and BGM inner model, it was observed that large errors can occur for shorter exposure dates when using MTM regression. The inventor believes that these large errors are also caused by extrapolation due to the mapping procedure used to map risk factors from the outer model to the inner model. As described below, the inner model BGM risk factors and the remaining forward rates are calculated from the Hull-White risk factors using the zero bond formula and then floored to a small number to ensure they are positive (as BGM requires positive forward rates). For shorter exposure dates, very few paths generated using the MTM distribution will have forward rates near zero as forward rates in the inner BGM model are lognormal. However, forward rates generated using the Hull-White outer model can have negative values. Thus, the mapped inner model scenarios will have forward rates that are close to zero, which are far from the MTM distribution used for the regressions leading to extrapolation errors.

In the above numerical tests, the discount factor and ATM swaption volatility data was used as presented the following Tables 1 and 2.

TABLE 1
Test Discount Factor Data

| Time to Maturity | |
|---|---|
| (months) | Discount Factor |
| 1 | 0.9977 |
| 3 | 0.9941 |
| 6 | 0.9845 |
| 9 | 0.9763 |
| 12 | 0.9681 |
| 24 | 0.9337 |
| 36 | 0.8919 |
| 48 | 0.8505 |
| 60 | 0.8101 |
| 72 | 0.7702 |
| 84 | 0.7295 |
| 96 | 0.6913 |
| 108 | 0.6552 |
| 120 | 0.6193 |
| 132 | 0.5872 |
| 144 | 0.5539 |
| 156 | 0.5257 |
| 168 | 0.4973 |
| 180 | 0.4693 |
| 240 | 0.3571 |
| 300 | 0.2738 |
| 360 | 0.2101 |
| 480 | 0.1217 |
| 600 | 0.0681 |

TABLE 2
ATM Swaption Volatility Data

| Expiry | Swap Length (years) | | | | | | |
|---|---|---|---|---|---|---|---|
| (months) | 1 | 2 | 3 | 4 | 5 | 6 | 7 |
| 3 | 34.6 | 36.3 | 33.2 | 31.7 | 30.7 | 28.9 | 26.7 |
| 6 | 35.5 | 33.7 | 30.8 | 29.5 | 28.3 | 26.8 | 25.1 |
| 12 | 32.7 | 30.3 | 28.3 | 26.8 | 25.5 | 24.1 | 23.5 |
| 24 | 25.8 | 24.7 | 24.3 | 23.5 | 22.3 | 21.8 | 21.1 |
| 36 | 22.8 | 22.3 | 21.7 | 21.1 | 20.5 | 19.8 | 19.3 |
| 48 | 21.5 | 21.0 | 20.2 | 19.7 | 19.3 | 18.8 | 18.5 |
| 60 | 19.9 | 19.2 | 18.8 | 18.5 | 18.1 | 17.8 | 17.6 |
| 84 | 17.7 | 17.5 | 17.1 | 16.9 | 16.7 | 16.5 | 16.2 |
| 120 | 15.5 | 15.1 | 15.0 | 15.0 | 14.9 | 14.7 | 14.6 |
| Expiry | Swap Length (years) | | | | | | |
| (months) | 8 | 9 | 10 | 15 | 20 | 25 | 30 |
| 3 | 25.2 | 23.8 | 22.3 | 20.3 | 19.1 | 18.8 | 18.5 |
| 6 | 23.8 | 22.5 | 21.3 | 19.1 | 18.5 | 18.2 | 17.8 |
| 12 | 22.6 | 21.5 | 20.7 | 18.6 | 17.8 | 17.6 | 17.4 |
| 24 | 20.3 | 19.9 | 19.3 | 17.7 | 17.1 | 16.9 | 16.5 |
| 36 | 19.1 | 18.7 | 18.3 | 16.9 | 16.5 | 16.3 | 16.1 |
| 48 | 18.1 | 17.8 | 17.5 | 16.3 | 16.0 | 15.8 | 15.6 |
| 60 | 17.5 | 17.3 | 16.8 | 15.9 | 15.5 | 15.3 | 15.2 |
| 84 | 16.0 | 15.8 | 15.7 | 14.6 | 14.3 | 14.2 | 14.1 |
| 120 | 14.5 | 14.3 | 14.1 | 13.3 | 13.1 | 13.1 | 13.0 |

For examples with a single factor Hull-White model, a mean reversion parameter of a=0.05 was used, and the model was calibrated to a swaption diagonal. For both BGM and a multi-factor Hull-White models, the models are calibrated by performing an optimization on the entire ATM swaption matrix.

The BGM model was calibrated using the Pedersen method. A five factor BGM model was used based on quarterly forward rates and a 0.25 year fraction for all periods. For the Pedersen volatility grid discretization, the calendar time, tⱼ, may be used along with a forward time, xₖ, discretizations provided by:

Tⱼ={0.25,0.5,1,2,3,5,7,10,20} Equation 17:

Xₖ={0.25,0.5,1,2,3,5,7,10,15,20,30,40,50} Equation 18:

A smoothness constant of 0.0005 was used for both calendar time and forward time smoothing. Further, the correlation structure was based on a time-homogeneous version of the following parametric form (e.g., that proposed by Rebonato in 2004):

ρ_{i,j}=ρ [symbol] +(1−ρ [symbol] )exp[−(β₀+β₁Max[τᵢ,τⱼ])|τᵢ−τⱼ|] Equation 19:

where τᵢ=Tᵢ−t and τⱼ=Tⱼ−t are the relative time to maturities of the two forward rates Fᵢ and Fⱼ. In the test cases, the values=ρ [symbol] ∞, 0.3, β₀=0.12, and β₁=0.005 were used.

In the multi-factor Hull-White model, the parametermization as proposed by Andreasen was used. A four factor model was used with the following constant mean reversions and benchmark tenors:

K=[0.01,0.1 0.3,1.2], τ=[0.5,2,10,30] Equation 20:

The model benchmark forward rate volatilities are piecewise constant functions of time with the same discretization as the expiries of the swaption volatility matrix presented in Table 2. The same parametric form as provide in Equation 19 was used to specify benchmark rate correlations. Values for the model benchmark forward rate volatilities were obtained by performing an optimization on the ATM swaption matrix. The procedure to obtain the more familiar Hull-White model parameters from the benchmark rate parameters may be implemented as described by Andreasen.

At this point, it may be useful to describe the procedures used to map scenarios from the outer model to the inner model. When the inner model is a single factor Hull-White model under the T forward measure, the inner model risk factor, Xᵢₙₙₑᵣ(t)=x(t), may be determined so that the value of the zero coupon bond maturing at time T is reproduced. In other words, for each scenario at time t, one can select x^{(k)}(t) by satisfying the following equation:

P(t,T,X^{(k)}(t))=P(t,TXₒᵤₜₑᵣ^{(k)}(t)) Equation 21:

The analytic bond formula for the Hull-White model is applied here.

When the inner model is a multi-factor Hull-White model, the inner model risk factor Xᵢₙₙₑᵣ(t) is determined so that the set of bonds with expiries corresponding to the benchmark tenors, τ, are reproduced. In other words, the set of bonds, P(t, t+τ), are reproduced where τ is given in Equation 20. Again, using the analytic bond formula, this involves solving a linear system. When a BGM model is used as the inner model, the inner model risk factors are the remaining forward rates, Fᵢ(t) at time t (the unexpired forward rates). The values for Fᵢ(t) can be calculated using the outer model and flooring them with a small value, ∈, as they are lognormal in the BGM model and cannot take on negative values (e.g., use ∈=10-12 in the test examples).

With the above detailed discussion of PFE determinations understood, it may be desirable to more generally discuss how these concepts may be implemented in real world settings or by users of the methods in the financial industry. FIG. 19 illustrates a flow diagram of a method 1900 for performing potential future exposure (PFE) calculations. The method 1900 typically is carried out by a computer or computing device with a processor executing code or software accessible in computer readable media or memory on the computer or via a network. For example, a PFE-determination engine or tool may be provided as part of a suite of software products running on or executed by a device(s) within a computer system or network (e.g., a counterparty credit risk management system). In other words, the computer (or one or more processors) may function as shown in method 1900 when executing the PFE engine or its associated instructions or code.

As a first step at 1910, a portfolio of trades with a given counterparty is identified by a user/operator. For example, the operator/user may initiate PFE-determination engine on their workstation or portable computing device and select a portfolio associated with a particular counterparty from a set of such portfolios stored in local or network-accessible memory. The portfolio chosen at 1910 may include a number of exotic products such as certain derivatives or exotic interest rate products for which conventional PFE calculations would be too computationally intensive/expensive.

At step 1920, the method 1900 continues with generating PFE scenarios at a plurality of exposure dates. As discussed above, the PFE scenarios may be generated by using a Monte Carlo simulation of an outer model. Again, performance of step 1920 is typically performed by a processor(s) executing the PFE-determination engine. A user/operator may be required to select or input a number of parameters (or use default values) presented, in some cases, by the PFE-determination engine in a user interface or graphical user interface (GUI) such as in dropdown boxes or the like or may provide their input in or as comma separate value (CSV) files or other more raw data entry formats.

For example, to perform the PFE calculation 1900 and step 1920, in particular, the user may be prompted to specify one or more of: (a) an outer model for use in generating the PFE scenarios including model parameters (as/if required for the model); (b) directions on how to generate the scenarios (e.g., how to perform the Monte Carlo simulation at the user-selected or default outer model); (c) a number of scenarios to be generated by the PFE-determination engine (e.g., default may be 100 and the user can tune the step 1920 by varying from this number of scenarios); and (d) exposure dates upon which to generate the scenarios.

The method 1900 continues at 1930 with calculation of expectations (e.g., expected future values of the portfolio). Expectations are determined for each trade in the user-selected trade portfolio for each PFE scenario at each exposure date. The calculation of expectations may be performed by or using the hybrid resimulation-regression approach discussed in detail above and shown to be effective with the numerical test cases. The PFE-determination engine may be configured to prompt the user/operator of the device running the engine to specify how the expected future values (or expectations) are to be calculated for each trade in the portfolio (with examples of how these values are determined provided above).

With regard to expected future value calculations, it will be appreciated by those skilled in the art that this step 1930 often will be the most computationally intensive step, and this is especially true for when the selected portfolio has a large number of trades. For simple trades that can be processed with analytic formulae, the expectations can be calculated directly from the outer model. However, for more complicated trades (i.e., exotics or exotic products), the expectations are calculated in step 1930 using a numerical method (e.g., finite difference, Monte Carlo simulation (i.e., a second or nested use of this simulation technique), or the like) with an inner pricing model. As with the outer model, the PFE-determination engine typically will prompt the user/operator to specify an inner model for use in step 1930 that should be used to price each trade (e.g., selected a default inner model with default model parameters or select one from a set of such models and provide model parameters or use default ones) The hybrid resimulation-regression approach taught herein presents a computationally efficient way (via a processor executing instructions to perform the functions/steps of the hybrid approach) to perform this part 1930 of the PFE calculation method 1900 especially when using nested Monte Carlo simulation.

The method 1900 continues at 1940 with calculating the exposure of the portfolio of trades. Typically, this may involve the PFE-determination engine using individual results for each trade for each PFE scenario at each exposure date. Further, the PFE-determination engine may prompt the user to select a default technique or to select one from a number techniques for combining the individual trade results to determine the overall exposure of the portfolio (e.g., specify netting rules or the like).

The method 1900 continues at 1950 with generating the PFE profile for the portfolio of trades, and the PFE-determination engine or tool may complete this task in part using the exposure distribution at each exposure date. The user may specify the percentile of the distribution to which the PFE corresponds (e.g., default may be the 95^{th} percentile and the user may tune the PFE-determination tool/engine to suit their needs or planned use for the output PFEs from method 1900). The method 1900 may end with step 1940 or with step 1950, i.e., with a determination of the PFE or PFE profile. Often, though, the method 1900 will continue with step 1960 where the results or product of the PFE calculation are output for additional processing or for direct use. For example, the PFE profile may be used for regulatory reporting, may be used to determine capital requirements (e.g., combine exposures across all or a set of portfolios to determine and manage counterparty credit risk of an institution), may be used to set credit limits with a particular counterparty, and so on.

In many cases, the method 1900 is performed by using the hybrid resimulation-regression process for or as part of step 1930 (e.g., to determine expectations for each trade in the portfolio at each exposure date). To use the hybrid resimulation-regression process or approach, the user/operator may be prompted by the PFE-determination engine or otherwise provide/enter for each trade one or more of the following (or a default value/model/procedure may be used by the engine): (a) an inner model used to price the trade (including model parameters); (b) a mapping procedure that defines for each outer model scenario how inner model risk factors can be determined from the outer model risk factors; (c) a procedure to perform the MC simulation for the inner model; (d) a number of MC resimulation paths to use for pricing each scenario of the outer model; (e) a procedure for pricing the trade using the inner model MC simulation; and (f) a specification of how to perform the least squares regression used to approximate the expectations for the expected future values.

FIG. 20 illustrates a flow diagram for a standard full resimulation procedure 2000. In this procedure 2000, a number of PFE scenarios are retrieved or generated at step 2010. Then, at step 2020, a Monte Carlo resimulation is performed that may involve, for each of the PFE scenarios (or Nₛ PFE scenarios), performing a Monte Carlo simulation using a predefined or calculated number of paths (e.g., using N_{RS} paths). Then, at 2030, the method 2000 involves determining the N_{S}·N_{RS} Monte Carlo paths, and, at 2040, the full resimulation estimate for expectation V_{RS} is calculated. For example, for each of the N_{S} PFE scenarios, V_{RS} is calculated by averaging over only the N_{RS} paths generated for the given PFE scenario.

FIG. 21 illustrates a flow diagram for a hybrid resimulation-regression procedure 2100 such as may be used by a PFE-determination engine or tool to perform portions of method 1900 such as step 1930. As shown, the method 2100 begins at 2110 with retrieving from memory or generating a number of PFE scenarios (e.g., N_{S} PFE scenarios at exposure dates for a portfolio of trades). At 2120, Monte Carlo resimulation 2120 is performed. This may involve, for each of the Nₛ PFE scenarios, performing a Monte Carlo simulation using N_{RS} paths. At step 2130, the N_{S}·N_{RS} Monte Carlo paths are determined/retrieved, and then at 2140, the hybrid regression estimate for expectation V_{H} is calculated. This latter step 2140 may involve calculating VH by performing a least squares regression using all N_{S}·N_{RS} Monte Carlo paths generated in the resimulation procedure 2120.

FIG. 22 illustrates a flow diagram for a hybrid resimulation-regression procedure 2200 using a combined estimator, and this method 2200 may be used to perform portions of the method 1900 of FIG. 19 (e.g., step 1930) to provide a PFE profile for a portfolio of trades. The method 2200 begins with retrieving or generating a set/number (N_{S}) of PFE scenarios at step 2210. At 2220, the method 2200 includes performing a Monte Carlo resimulation. For example, for each of the N_{S} PFE scenarios from step 2210, perform a Monte Carlo simulation using a number (N_{RS}) of paths. At 2230, the N_{S}·N_{RS} Monte Carlo paths are generated or output. Then, at 2240, a full resimulation estimate for expectation, V_{RS}, is calculated while, at 2250, a hybrid regression estimate for expectation, V_{H}, is calculated. The method 2200 further includes at 2260 the calculation of a combined estimate for the expectation, V_{C}. As can be seen, in method 2200, expectation, V_{C}, is calculated using results obtained from both the full resimulation estimate (from step 2240) and the hybrid regression estimate (from step 2250).

FIG. 23 illustrates a system or network 2300 that may operate to implement and/or perform the hybrid PFE-determination techniques and methods taught herein. Particularly, the network 2300 is shown to include a counterparty credit risk management system 2310 that is communicatively linked (in a wired or wireless manner) via a digital communications network (e.g., the Internet, an intranet, or the like) 2370 with a number of client nodes 2380 (e.g., any electronic device operable to communicate over the network 2370 with the system 2310 such as a desktop, a laptop, notebook, or tablet computer or a smartphone/portable network-enable device or the like). The system 2310 may be one or more servers or other computing devices that provide financial services and information to operators of the client nodes 2380.

Particularly, an operator of a client node 2380 may access the system 2310 to determine counterparty credit risk associated with one or more of their actual or proposed trading portfolios (as shown at 2342). To this end, the client node 2380 may include a monitor, GUI, and/or other I/O devices 2382 that allow it to communicate with the system 2310 such as to request a PFE profile or other data be generated by the system 2310 and to provide selections or user input to facilitate such calculations (e.g., select an outer model, an inner pricing model, and so on for use in PFE calculations).

When the system 2310 completes the requested task, the system 2310 may report out the results for use by the client node 2380. For example, the node 2380 may receive a PFE profile for one of the portfolio of trades 2342 and act to update the monitor and its GUI 2382 to display the PFE profile 2385 (e.g., in graphical and/or numerical fashion). The PFE profile 2385 may be used at the client node (as discussed at step 1960 of method 1900) for additional purposes such as regulatory reporting, determining capital requirements, setting credit limits with a counterparty, and so on or these tasks may be performed by the risk management system 2310 and the result provided to the node 2380 for viewing/use such as via the monitor/GUI 2382.

The system 2310 is configured or adapted to perform the methods 1900, 2000, 2100, 2200, and embodiments of the hybrid resimulation-regression approach discussed herein. To this end, the system 2310 is shown to include one or more processors (or central processing units) 2312, and, generally, the system 2310 may be thought of a special purpose computer or computing device such as a server or the like that performs the described methods/functions when it executes code or instructions stored in computer readable media or memory devices. The processor 2312 manages operation of I/O devices 2314 and memory/data storage 2340. The I/O devices 2314 may include devices such as a keyboard, a touchpad, a mouse, a touchscreen, voice-recognition software/firmware/hardware, and a monitor. The monitor 2316 may be operated (such as by execution of the PFE determination engine/tool 2320) to generate and present a graphical user interface (GUI) 2316. This is useful in some embodiments of system 2310 where the system 2310 is operated by a user/operator to control operations of the PFE determination engine/tool 2320 rather than (or in addition to) a client node 2380, which may include input or selection of operating variables or parameters of the engine 2320.

During operation of the system 2310, the processor 2312 executes computer program code or instructions from memory or a computer readable medium to provide the PFE determination engine/tool 2320. As discussed above, the engine 2320 may be used to perform all or portions of the methods 1900, 2000, 2100, and 2200 shown in FIGS. 19-22 (or otherwise perform the methods/functions described herein). To this end, the engine/tool 2320 may include a variety of subroutines/modules including, but not limited to, a Monte Carlo module 2322 for performing MC simulations, a least squares module 2324 for performing regressions, and a combined estimator module 2326 for use in PFE calculations involving the combined estimator approach. When run on a portfolio of trades, the engine/tool outputs PFEs and/or PFE profiles such as shown at 2385.

As discussed above, there are a number of parameters and tools or settings that are used by the engine 2320 to perform the PFE calculations. As shown, in FIG. 23, the memory 2340 may store (or these and the other items in memory 2340 may be accessible in other memory by the engine 2320) a portfolio of trades 2342 each typically including one or more exotic products/trades 2343. A user of the engine 2320 such as an operator of a client node 2380 generally initiates the engine 2320 and then selects one or more of the portfolio of trades 2342 for use in a PFE calculation by the engine 2320.

Further, the user/operator may use a default or select an alternative outer model 2344 for use by the engine/tool in generating scenarios, and the user will set the number of scenarios to generate as shown at 2348 (e.g., around 1000 may be useful in many applications of engine 2320). The user also may select (e.g., via GUI 2316 or 2382) the exposure dates 2350 upon which the scenarios are generated. The user input may also define how the MC module 2322 is to perform the Monte Carlo simulation for the outer model 2344.

The user may also select an inner model 2346 such as a particular numerical method (e.g., finite difference or Monte Carlo simulation (again)) for use by the engine in pricing of the trades or determining expectations. Further, the user/operator may be asked to choose a default or define another distribution percentile value 2352 setting what percentile of the distribution the PFE provided by the engine 2320 corresponds to. Still further, the user or operator may select or define the mapping procedure 2356 used to define for each outer model scenario how the inner model risk factors can be determined from the outer model risk factors. The memory 2340 is also shown to store a default or user-selected process for use by the engine 2320 to combine the individual trade results to determine overall exposure of the portfolio (e.g., netting rules or the like).

Embodiments of the subject matter described in this specification can be implemented as one or more computer program products, i.e., one or more modules of computer program instructions encoded on a computer-readable medium for execution by, or to control the operation of, data processing apparatus. For example, the modules/software used to provide the architecture/system 2300 such as the module/engine/tool 2320 and similar modules/software may be provided in such computer-readable medium and executed by processor(s) 2312. The computer-readable medium can be a machine-readable storage device, a machine-readable storage substrate, a memory device, a composition of matter affecting a machine-readable propagated signal, or a combination of one or more of these types of media. The terms system and counterparty credit risk management system encompass all apparatus, devices, and machines for processing data including, e.g., a programmable processor, a computer, or multiple processors or computers. The system (such as devices and servers in system 2300 of FIG. 23) can include, in addition to hardware, code that creates an execution environment for the computer program, e.g., code that constitutes processor firmware, a protocol stack, a database management system, an operating system, or a combination of one or more of these items.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification (such as those of FIGS. 19-22) can be performed by one or more programmable processors executing one or more computer programs to perform functions by operating on input data and generating output. The processes and logic flows can also be performed by, and apparatus can also be implemented as, special purpose logic circuitry. Processors suitable for the execution of a computer program include, e.g., both general and special purpose microprocessors, and any one or more processors of any kind of digital computer. Generally, a processor receives instructions and data from a read-only memory or a random access memory or both. Generally, the elements of a computer are a processor for performing instructions and one or more memory devices for storing instructions and data. The techniques described herein may be implemented by a computer system configured to provide the functionality described.

For example, FIG. 23 is a block diagram illustrating one embodiment of a computer system configured to implement the methods described herein such as with reference to FIGS. 19-22. In different embodiments, the system 2310 and client nodes 2380 may be any of various types of devices including, but not limited to, a personal computer system, desktop computer, laptop computer, notebook computer, netbook computer, mainframe computer system, handheld computer, workstation, network computer, application server, storage device, a consumer electronics device (e.g., camera, camcorder, set top box, mobile device, video game console, handheld video game device, etc.), a peripheral device (e.g., switch, modem, router, etc.), or, in general, any type of computing or electronic device.

Typically, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, a digital camera, etc. Computer-readable media suitable for storing computer program instructions and data include all forms of non-volatile memory, media and memory devices, including, e.g., semiconductor memory devices (e.g., EPROM, EEPROM, and flash memory devices), magnetic disks (e.g., internal hard disks or removable disks), magneto-optical disks, and CD-ROM and DVD-ROM disks. The processor and the memory can be supplemented by, or incorporated in, special purpose logic circuitry.

While this document contains many specific details, these details should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this depiction should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software and/or hardware product or packaged into multiple software and/or hardware products.

The above description described the use of the least squares regression technique for PFE calculations. The inventor identified two important sources of error when using regression for PFE calculations: distribution error and projection error. Two methods were thus described that attempt to address the issues associated with these types of errors. In this regard, a hybrid regression-resimulation approach was described to deal with distribution errors and a bucketed regression approach was described to deal with or address projection errors. The numerical results from test cases presented herein showed the possible improvements that can be achieved in PFE calculations using these two techniques.

The techniques presented herein may be applied to credit valuation adjustments (CVAs), which require similar calculations as found with PFEs. Although for CVA calculations, a risk neutral measure is often used when simulating the outer model (as opposed to a real world measure for PFE), the inner model used for pricing could still be different from the outer model used for scenario generation. Further, the techniques may be used for nearly any future exposure-type calculation such as for initial margin calculations and the future exposures may be used in collateral posting and for performing pre-deal checks.

I claim:

1. A method for generating a potential future exposure (PFE) profile, comprising;
providing a PFE-determination engine with a processor executing code accessible in a computer-readable medium;
with the PFE-determination engine, generating PFE scenarios for a portfolio of trades stored in memory at a number of exposure dates;
with the PFE-determination engine, calculating, for each of the trades in the portfolio at each of the exposure dates, expected future values;
calculating exposure of the portfolio based on the calculated expected future values; and
generating a PFE profile using a distribution of the exposure at each of the exposure dates.

2. The method of claim 1, wherein the calculating of the expected future values comprises calculating hybrid regression estimates for the expected future values.

3. The method of claim 2, further comprising using a combined estimator using the hybrid regression estimates along with data from a full resimulation estimate for the expected future values to provide the calculated expected future values.

4. The method of claim 1, wherein the trades include a number of exotic products and wherein the calculating of the expected future values is performed using a numerical method with an inner pricing model.

5. The method of claim 4, wherein the numerical method comprises performing a Monte Carlo simulation.

6. The method of claim 1, further comprising using the generated PFE profile to perform regulatory reporting, to determine capital requirements for the portfolio of trades, to set credit limits with a counterparty associated with the portfolio of trades, to calculate collateral posting, or to perform pre-deal checks.

7. A computer-readable storage medium with an executable program stored thereon causing a computer to perform the following steps:
performing a Monte Carlo simulation to generate future exposure scenarios for a portfolio of trades;
for each of the trades, calculating expectations at a set of exposure dates using least squares regression; and
for each of the future exposure scenarios at the exposure dates, determining exposure of the portfolio based on the calculated expectations.

8. The computer readable medium of claim 7, wherein the future exposure scenarios include PFE scenarios.

9. The computer readable medium of claim 8, wherein the computer further performs the step of generating a PFE profile using a distribution of the determined exposure at each of the exposure dates.

10. The computer readable medium of claim 9, wherein the computer further performs the step of determining capital requirements using the PFE profile or the step of setting credit limits with a counterparty associated with one or more of the trades.

11. The computer readable medium of claim 7, wherein the performing of the Monte Carlo simulation generates at least about 900 of the scenarios using Monte Carlo simulation of an outer model.

12. The computer readable medium of claim 7, wherein the calculating of the expectations comprises calculating hybrid regression estimates for the expected future values and the computer further performs the step of using a combined estimator using the hybrid regression estimates along with data from a full resimulation estimate for the expectations to provide the calculated expectations.

13. The computer readable medium of claim 7, wherein the trades include a number of exotic products and wherein the calculating of the expectations further involves using Monte Carlo simulation with an inner pricing model.

14. A system for performing financial risk management, comprising:
memory storing exotic trades; and
a processor executing code to perform:
generating future exposure scenarios for the exotic trades at a plurality of predefined exposure dates;
determining, for the exotic trades in the portfolio at each of the exposure dates, expected future values; and
calculating exposure of the portfolio based on the calculated expected future values.

15. The system of claim 14, wherein the calculating of the expected future values comprises calculating hybrid regression estimates for the expected future values, and the processor further performs the step of using a combined estimator using the hybrid regression estimates along with data from a full resimulation estimate for the expected future values to provide the calculated expected future values.

16. The system of claim 14, wherein the determining of the expected future values is performed using Monte Carlo simulation with an inner pricing model.

17. The system of claim 14, wherein the future exposure scenarios are PFE scenarios and the processor further performs:
generating a PFE profile using a distribution of the exposure at each of the exposure dates; and
using the generated PFE profile to perform regulatory reporting, to determine capital requirements for the exotic trades, or to set credit limits with a counterparty associated with the exotic trades.

18. The system of claim 14, wherein the calculated exposure is used as input for a future exposure-type calculation.

19. The system of claim 18, wherein the future exposure-type calculation is a credit value adjustment calculation, an initial margin calculation, a counterparty credit limit calculation, or a capital requirements calculation.
